(19) United States
(12) Patent Application Publication
(10) Pub. No.: US 2013/0297335 A1
(43) Pub. Date: Nov. 7, 2013

(54) Coupling Plant Air Purification with Wellness, Prevention and Insurance Programs

(71) Applicant: Martin Mittelmark, Saratoga Springs, NY (US)

(72) Inventor: Martin Mittelmark, Saratoga Springs, NY (US)

(21) Appl. No.: 13/858,851

(22) Filed: Apr. 8, 2013

Related U.S. Application Data
(63) Continuation-in-part of application No. 13/580,159, filed on Aug. 21, 2012.
Application No. 13/580,159 is a continuation-in-part of application No. 13/060,668, filed on Feb. 24, 2011.
Application No. 13/060,668 is a continuation-in-part of application No. 13/062,580, filed on Mar. 7, 2011, now Pat. No. 8,083,835.
Application No. 13/062,580 is a continuation-in-part of application No. 13/334,260, filed on Dec. 22, 2011, now Pat. No. 8,454,729.
Application No. 13/334,260 is a continuation-in-part of application No. 13/062,580, filed on Mar. 7, 2011, now Pat. No. 8,083,835.
Application No. 13/062,580 is a continuation-in-part of application No. 13/060,668, filed on Feb. 24, 2011.
(60) Provisional application No. 61/624,831, filed on Apr. 16, 2012.
(60) Provisional application No. 61/642,835, filed on May 4, 2012.
(60) Provisional application No. 61/314,215, filed on Mar. 16, 2010.
(60) Provisional application No. 61/098,314, filed on Sep. 19, 2008.
(60) Provisional application No. 61/098,314, filed on Sep. 19, 2008.

(30) Foreign Application Priority Data
Sep. 11, 2009 (US) PCT/US2009/056581

(51) Int. Cl. G06Q 40/08; G06Q 50/22

(52) U.S. Cl. CPC G06Q 40/08; G06Q 50/22
USPC 705/2

(57) ABSTRACT

A method by which an organization with plurality of employees and/or insureds and/or members takes steps intended to reduce its costs for providing healthcare, by establishing a wellness and prevention program which comprises at least one of the following: paying for costs of installing plant air purifiers in a workplace of said employees and/or insureds and/or members; paying for costs of installing plant air purifiers in places of residence of said employees and/or insureds; wherein: said plant air purifiers include a mechanism for forcing air to pass through a filter bed thereof in which said plants are rooted.

### CROSS REFERENCE TO RELATED APPLICATIONS

This application claims priority benefit of pending provisional application U.S. 61/624,831 filed Apr. 16, 2012. This application also claims priority of benefit of pending provisional application U.S. 61/624,835 filed Apr. 16, 2012. This application is also a continuation-in-part of pending application U.S. Ser. No. 13/580,159 filed Aug. 21, 2012. Said U.S. Ser. No. 13/580,159 is a US national stage application of PCT/US11/27860 filed Mar. 10, 2011. Said PCT/US11/27860 claims priority benefit of expired provisional application U.S. 61/314,215 filed Mar. 16, 2010, and is also a continuation-in-part of pending application U.S. Ser. No. 13/060,668 filed Feb. 24, 2011 and U.S. Ser. No. 13/062,580 filed Mar. 7, 2011, now U.S. Pat. No. 8,083,835 issued Dec. 27, 2011. This application is also a continuation-in-part of pending application U.S. Ser. No. 13/334,260 filed Dec. 22, 2011. Said U.S. Ser. No. 13/334,260 is a continuation of said application U.S. Ser. No. 13/062,580 filed Mar. 7, 2011, now said U.S. Pat. No. 8,083,835 issued Dec. 27, 2011. Said U.S. Ser. No. 13/062,580 is a national stage of application PCT/US09/56581 filed Sep. 11, 2009, which claims benefit of provisional application U.S. 61/098,314 filed Sep. 19, 2008. This application is also a continuation-in-part of said pending application U.S. Ser. No. 13/060,668 filed Feb. 24, 2011. Said U.S. Ser. No. 13/060,668 is a US national stage application of PCT/US09/57392 filed Sep. 18, 2009, which also claims benefit of provisional application U.S. 61/098,314 filed Sep. 19, 2008. All of the foregoing are hereby incorporated by reference.

### BACKGROUND OF THE INVENTION

At the moment the United States health care system is one of the most costly in the world per capita. We spend a larger percentage of gross national product on health care, over 17.3% than almost any other country and yet United States life expectancy is 36th in the world, lagging behind many other industrialized nations including the other nations of the G5-Japan, France, Germany, UK, etc. In addition, our infant mortality rate places us 34^{th} or 49^{th} in the world depending on whether one looks at United Nations data or that furnished from the CIA World Fact Book. So bad is our health care system that our infant mortality rate is 2½ to 3 times higher than that of certain other countries.

To make matters worse, as shown in FIG. 1, costs for medical treatment in the United States are rising at a faster pace than elsewhere.

This places United States business at a distinct disadvantage, especially when it comes to production of goods and services; and now with the new Affordable Care Act, especially after 2014 when health insurance will be mandatory, we will be even less competitive than before. Ways must be found to reduce health care costs, to improve the health of our citizenry and to make our country more competitive in the market place. But it will not come until such time as we eat better, exercise more, and limit the amount of harmful chemicals and radioactive substances we ingest and breathe in.

Man is biological and he must live in harmony with nature rather than oppose it. Otherwise we will continue to be caught up in an ever increasing spiral of higher and higher health care costs with little improvement in our wellbeing, as has been our pattern for almost half a century.

So we must make fundamental changes, address what gives rise to our highest health care expenditures, and find ways of prevention rather than cure so as to bring costs down. The Congressional Budget Office has found that “about half of all growth in health care spending in the past several decades was associated with changes in medical care made possible by advances in technology.” Yet such treatment is not cost effective, otherwise levels of chronic illness would have decreased. Yet they have not. Therefore a different path must be taken.

With this in mind, we propose a business method of coupling plant air purification with normal health insurance so as to reduce health costs, lower incidence of chronic illness both now and in the future and increase wellbeing. We propose the installation of plant air purifiers in both the workplace and the home where America's citizenry spend the vast majority of its time, and in this way they can be protected against airborne pollutants—chemical, biological, radioactive and particulate which we breathe in every few seconds of our lives and which give rise to many of the chronic illnesses that Americans suffer from and which increase medical expenditures and medical insurance. Further, if such installations of plant air purifiers were to occur, expenditure on heating and cooling of our structures in this country would be reduced as a byproduct and we would reduce our carbon footprint on the world.

Right now the cost of medical treatment is so expensive that everyone dreads coming down with a chronic illness, especially if they have to foot the bill alone. And when it does occur, it often results in financial ruin for both the sufferer and his family. In fact in 2007, 62.1% of filers for bankruptcy claimed high medical expenses as one of the main reasons for filing. As a result, American workers look to health insurance as a means of protection. And it is the offering of health insurance by an employer which can determine where a person works. Yet health insurance rates have been rising at a staggering pace for many years now, and between 2001 and 2011 the cost of group health insurance, as furnished by an employer, has risen by 113%, while inflation during the same time only increased by 27%. This increased cost has drained business of needed funds which it could use elsewhere. Yet business has had no choice but to provide health insurance as a benefit in order to be competitive and herein lies the dilemma. How does business protects its workforce and give them what they demand, while at the same time lower its cost? This can only occur if we address major health insurance expenditures and find a better way to address the problem.

Group health insurance is a type of insurance coverage that pays for medical and surgical expenses were illness to occur for any member of the group. Right now group health insurance spends an inordinate amount of its revenues on the treatment of chronic illness when such illness develops. A chronic disease is one lasting 3 months or more according to the definition of the U.S. National Center for Health Statistics.

According to the Centers for Disease Control and Prevention, chronic diseases such as asthma, cancer, diabetes and heart disease account for more than 75 cents of every dollar spent on health care yet these payments go only to help treat a small percentage of the insured group, while doing nothing to prevent illness or protect the other members of the group from the same risk which will befall them in the years to come.

Health costs for the top one percent of those in the U.S. Civilian non-institutionalized population under age 65, who are chronically ill, cost 24% of available funds utilized for health purposes; expenditures for treating the top five percent of those who are ill cost 49%; while the top ten percent of the sickest drain 64% of the funds available. (This was ascertained in a study performed in 2002 by the Agency for Healthcare Research and Quality). Meanwhile, only 3% of medical expenditures go to the lower 50% of those in a health insurance pool. Yet this same lower 50%, who are now healthy, will get older and as the years progress more and more of them will undoubted fall prey to the same types of disease as those who are chronically ill presently. So the cost to the pool can only rise higher and higher in the future if a preventative program is not instituted today. For a health insurance plan to be effective it must protect all members, and not just deal with those who are currently sick, otherwise costs will continue to spiral upward, especially if rates of chronic illness are increasing in the population at large.

In a study examining the overall profile and costs associated with the chronically ill, for commercially insured people under 65, it was found that the most costly treatments deal with the following diseases: breast cancer, lung cancer, GI cancer, NHL, Rheumatoid arthritis, Multiple sclerosis, Hepatitis C, Kidney disease, Diabetes mellitus, Coronary artery disease, Cerebrovascular accident or stroke, COPD and Asthma—some of which are on the increase for the population at large and many of which are affected by poor indoor quality air.

Further what has also been found is that an overwhelming number of these same diseases are often caused, or exacerbated, by poor quality air. Therefore any method which improved the quality of air people breathe should lower insurance costs and thus help to achieve our goal.

Plant air purifiers are a NASA spin off technology. They are different from other types of air purifiers. These purifiers use plants and the microbes around their root system to purify air and digest volatile organic compounds. Plus they take care of radioactivity within the air, limit biological threat and deal with particulate matter. Further, their filter beds rarely ever need replacement. In such systems air is pulled or pushed into/forced through a filter bed composed of sorbent material which traps the pollutants, and the plants and microbes which grow within the filter bed digest the pollutants or encapsulate them, using them as a source of food. As a result humans do not breathe in these harmful elements and people's health is improved.

In several patent application from which the present application claims priority, we show how plant air purifiers deal with ionizing radiation and so protect us from most chronic illnesses which radiation might cause. Looking through the next three maps of FIGS. 2 through 4—one dealing with radon, one with states having the highest incidence of smoking and second hand smoke, and one showing states with the highest incidence of chronic illness, an overlap is easily seen.

FIG. 2 shows incidence of radon in the United States, (a gas that emanates from the radioactive decay of Uranium in the soil). In the United States radon covers wide areas of the country and poses a serious health risk to people. The map of FIG. 2 shows where radon is located and in what concentrations. Notice the plume extending from Maine through Alabama.

FIG. 3 shows those states with the highest rates of cigarette smoking and second hand smoke. This is indicated by the areas marked in blue. The different colors shown on the map in FIG. 3 indicate the percentage of those 18 years or older who smoke. Referring to http://en.wikipedia.org/wiki/Polonium
The presence of polonium in tobacco smoke has been known since the early 1960s. Some of the world's biggest tobacco firms researched ways to remove the substance—to no avail—over a 40-year period but never published the results.
Radioactive polonium-210 contained in phosphate fertilizers is absorbed by the roots of plants (such as tobacco) and stored in its tissues. Tobacco plants fertilized by rock phosphates contain polonium-210.
Almost 95% of the Lung Cancer caused by Cigarettes are allegedly the result of using calcium phosphate fertilizer to grow the Tobacco. The resulting Cigarettes bearing a combination of local Radon gasses and radioactive Polonium from the Tobacco leaves deposit a small dose of radioactive isotopes directly into a smoker's lungs as they smoke (or as others breathe smoke laden air)! For the “pack-a-day” smoker, it has been alleged that this dose would be the same as if they were forced to have between 300 and 8000 Chest X-Rays a year.
Those breathing second hand smoke take such radioactive material into their lungs as well and so can develop illness from such an intake.

In FIG. 4, again in blue, are the states with the highest incidence in chronic illness.

By looking at both the radon map and the states with the highest percentage of smokers one sees an area extending down from Maine in a southwesterly direction to the Gulf. This is also the area making up the chronic disease belt (those states with the highest percentage of chronic disease per capita). In this belt are found high levels of radon to the north, and in the southwest, the highest levels of smoking and second smoke—all of which cause illness and disease through radioactive decay.

Plant air purifiers also remove radioactive elements from the air which emanate from nuclear power plants as well and more than one third of the American population lives within 50 miles of a nuclear reactor. Such radioactivity has a dramatic effect upon both the very young and old and it was found that when nuclear reactors were shut down, infant mortality in the counties where they existed, were reduced by 15-20%.

When people breathe in radioactive substances which emit alpha and beta particles as they decay—when they breathe in radon, cigarette smoke, or nuclear fallout—the chances of getting lung cancer are abnormally increased and the chances of getting other types of chronic disease markedly increased too. Meanwhile plant air purifiers remove ionizing radiation from the air and trap it, first in the filter bed of the plant air purifier, after which it is then drawn into the roots of the plants growing in the filter bed and encased in plant tissue so these same alpha and beta particles cannot enter a person's lungs and do damage, thus preventing people from harm and helping to make them safer. This is one of the many ways in which plant air purifiers protect individuals and clean the indoor environment, so protecting them from severe illness and harm.

Ionizing radiation is responsible for many diseases, It weakens the immune system and causes DNA damage, causes cancer of the bile ducts, bone, brain, breast, colon, esophagus, gall bladder, liver, lung (including bronchiolar-alveolar cancer), pancreas, pharynx, ovary, salivary gland, small intestine, stomach, thyroid, urinary tract (kidney/renal, pelvis, urinary bladder, and urethra). It also causes leukemia, lymphomas, multiple myeloma (cancer of plasma cells). and a number of degenerative diseases. It causes genetic diseases in progeny, heart disease and stroke and changes hormone levels. It damages woman's ovaries, which may result in hot flashes, sexual dysfunction, osteoporosis and early menopause. It increases infertility, erectile dysfunction, bone, joint, and soft tissue problems. It also causes brain, spinal cord, and nerve problems, hearing loss, learning, memory, and attention difficulties; gives rise to dental and vision problem, digestive problems; causes emotional difficulties and mental diseases such as schizophrenia, as well as causing premature aging, skin disease, heart valve disease, making hair fall out, and esophageal disorders. Plus it causes minor ailments as well, such as a persistent cough, headaches, sleep disturbances and gastrointestinal dysfunction. Any of these ailments if suffered by a member of a group health policy can cause an increase in medical costs to the insured group at large.

Radiation may well also be linked with a higher prevalence of multiple sclerosis and radon. In fact Margaret Gilmore and Eamonn Grennan, two lecturers at Sligo Institute of Technology, believe radon may be one of its triggers. Gilmore, a medical doctor who lectures in social studies, and Grennan, an environmental scientist, examined the membership of the MS Society in Ireland to see where the disease occurs most.

Then they looked at data from the Radiological Protection Institute of Ireland on radon levels around the country and what they discovered was that regions with higher levels of MS were broadly those which had greater radon emissions.

Sligo, which had one of the highest prevalence rates of MS, also had the highest levels of radon, according to data from the institute, with 20% of homes over the danger limit.

Plant air purifiers reduce danger to humans from radon and might well reduce the danger of multiple sclerosis as well.

Up to this point we have only dealt with different airborne radioactive pollutants which cause chronic illness. However plant air purifiers also take care of volatile organic compounds, or chemicals which cause chronic illness as well. Plant air purifiers remove literally thousands of VOCs from the air we breathe. VOCs off-gas continually from a myriad of manmade products which are in an indoor environment, from computers to laminates and glues, to paints and fiberboard. These carbon-based pollutants are actually digested by carbon-eating microbes around the root system of the plants within the plant air purifier. The microbes use them as a food source and turn them into plant food for the plants in the filter bed with which they have a symbiotic relationship.

One of the most prevalent of these VOCs which microbes deal with is formaldehyde, a well known carcinogen found to exist at dangerous levels in just about every structure in the country, places where people work and live.

Formaldehyde is a very toxic substance, so toxic that were it to make up just one part per billion of the air we breathe, it would have exceeded the lifetime chronic exposure level determined for humans by the EPA, as set forth in its draft Toxicological Review of Formaldehyde Inhalation Assessment Report, of June 2010. This study goes on to say that average ambient air levels of formaldehyde in the United States are found to be about 3 ppb (more than 3 times higher than what gives rise to cancer) and that indoor air levels are ten times greater than that which is considered safe, or more than 30 times higher than what can give rise to cancer. In one study, levels of this carcinogen were found in the average home to be as high as 55 ppb. This is a level so high that it presents an acute danger if we breathe in air at such levels longer than one hour a day; yet people live in homes where these high levels of contamination continue to exist day in and day out, year after year.

When California EPA conducted a study of 108 homes built between 2002 and 2004 in 2005, it was found that not one home could reach formaldehyde levels considered safe under Proposition 65 so as to have No Significant Risk Level for carcinogens, and fully 98 percent of the homes exceeded the 2008 Chronic 8-hour Reference Exposure Level for irritants, with 28 percent exceeding the 2008 Acute Reference Exposure Levels for irritants where one should not stay longer than one hour a day in such an environment.

When California conducted random air sampling of mobile homes it found a mean formaldehyde level of greater than 72 parts per billion; more than 72 times lifetime chronic exposure levels above what is considered safe.

When the U.S. EPA did a study of 100 office buildings all had levels of formaldehyde in their air supply that exceeded lifetime chronic exposure levels determined to be safe under the draft of the Toxicological Review of Formaldehyde Inhalation Assessment Report, of June 2010. Table 1 below shows a typical office building formaldehyde concentration from EPA-BASE.

| | | Building | | | | Analyte |
|---|---|---|---|---|---|---|
| | | Frequency | Analyte Concentration | | | Concentration |
| | Number | Detected | Indoors Percentile | | | Indoors |
| Analyte | of | Indoors | ug/m³(ppb) | | | Arithmetic Mean |
| (Indoors) | Buildings | (%) | 5th | 50th | 95th | ug/m³(ppb) |
| Formaldehyde | 100 | 100 | 4.4 (3.59) | 15 (12.23) | 32 (26.08) | 16 (13.04) |

When California EPA conducted its own study on the level of formaldehyde in office and public buildings, it found that the average office had a mean formaldehyde exposure level of 24 ppb, again more than 24 times what EPA's draft IRIS considered acceptable. Thus it is safe to say that in the vast majority of cases where the average American lives or works he or she is subject to a significant risk from cancer-causing agents from formaldehyde which all members of a health insurance group are continually breathing in, and which will result in at least some of them coming down with cancer, so increasing the cost to an employer group health insurance plan which they participate in.

Plant air purifiers remove formaldehyde and other VOCs from the air by utilizing a wet scrubber technique, where certain pollutant gases dissolve within moisture and are absorbed by liquid which surrounds filter bed material; after which friendly microbes which live in the filter digest them. Extensive testing conducted at both Syracuse University and at NASA proved that when plant air purifiers were used formaldehyde levels were reduced by 98.7% in just minutes.

By supplying plant air purifiers to the workplace and the homes of those within an employer health group, all people in that group are protected from VOC intake and by utilizing a program such as we propose prevention protection, as well as treatment is provided. This limits and mitigates the dangers of these airborne contaminants which cause cancer, kidney damage, liver damage, damage to the central nervous system (including the brain), as well as more minor complaints like headaches and eye, throat and nose irritation. Poor indoor quality air is considered among the five leading causes of disease in the county by the EPA and plant air purifiers address the problem by taking many different types of contaminants out of the air, not just one or two.

Radioactive and chemical contaminants in the air are not the only contaminants which cause harm to humans. There are also biological contaminants as well and these have to be removed if members of an insured health group are to be protected.

Biological contaminants include bacteria, fungi, mold, mildew, viruses, animal dander, cat saliva, house dust, mites, cockroaches, and pollen. They are either living organisms or come from living things and often are so small and light that they can become airborne and remain in the air for long periods of time, at which point humans breathe them in. They trigger allergic reactions, including hypersensitivity pneumonitis, allergic rhinitis, and some types of asthma. They spread infectious disease such as influenza, measles, tuberculosis and chicken pox and many release disease-causing toxins which can damage a variety of organs and tissues in the body, including the liver, central nervous system, digestive tract, and immune system. Symptoms caused by biological pollutants include sneezing, watery eyes, coughing, shortness of breath, dizziness, lethargy, fever, and digestive problems.

Because almost 60 million Americans suffer from allergies and almost 30 million suffer from asthma it is beneficial to those in a group health insurance plan if biological contaminants are removed from the air. Plant air purifiers accomplish this. They draw indoor air into the filter bed where such contaminants are trapped and where friendly microbes within the filter bed digest them. Nature and plants have been protecting both themselves and other species for millions of years from biological contaminants. In additions, certain plant air purifier systems have an ultra violet attachment which further increases the ability of these devices to protect group insurance health plan recipients. Plant air purifiers also protect against the spreading of communicable diseases, or the spreading of colds and flu. How often, especially in winter, has someone in the office come down with one of these and pretty soon everyone in the office has it? Plant air purifiers can dramatically limit such occurrences.

The last airborne contaminant plant air purifiers deal with is particulate matter. These are a mix of very tiny solid and liquid particles such as dust, dirt, soot, and smoke and are a complex mixture of organic and inorganic substances. They come in a range of sizes from those about one-tenth the diameter of a strand of hair down to the tiniest which can only be seen with an electron microscope Researchers categorize these particles according to size, grouping them as coarse, fine and ultrafine. Coarse particles fall between 2.5 microns and 10 microns in diameter and are called PM10. Fine particles are 2.5 microns in diameter or smaller and are called PM_{2.5}. Ultrafine particles are smaller than 0.1 micron in diameter and are small enough to pass through the lung tissue into the blood stream, circulating like oxygen molecules themselves.

Because of their size humans can't see these individual particles. All you can see is a haze formed by millions of them which blur the spread of sunlight. Nor can you tell when you're breathing them in, yet they are so dangerous they can shorten your life. In fact in a study conducted on over a half million people in 151 U.S. metropolitan areas during 1982-89 by Pope et al. (1995) it was found that death rates in the areas most polluted with fine particulates were 17% higher than in the least polluted areas, even when most of these cities complied with the U.S. federal standards for particulates.

As illustrated in FIG. 5, particles larger than PM10 are not nearly as dangerous as those that are smaller, for our natural defenses help us to cough or sneeze larger particles out of our bodies. But our defenses don't keep out smaller particles. These particles get trapped in the lungs, while the smallest are so minute that they can pass through the lungs directly into the blood stream. This can be very dangerous if some of these particulates are heavy metals, such as lead, mercury, or cadmium.

Where do these particulates come from? Many of those known as PM10 or lower are generated through combustion processes, such as diesel-fueled engine combustion, steam generation, heating, etc. or come from factories, power plants, steel mills, smelters, while others come from gasoline-powered motor vehicles (cars and trucks) from burning agricultural fields or forests. Others come from industrial processes that produce large amounts of dust, such as cement manufacturing, mining, stone crushing, and flour milling. PM_{2.5} is also produced by common indoor activities such as tobacco smoke, cooking (e.g., frying, sautéing, and broiling), burning candles or oil lamps, and operating fireplaces and fuel-burning space heaters (e.g., kerosene heaters).

Some of those processes like those where coal is burned in power generation produce fine particulates which even contain lead, mercury, and other heavy metals while melting, pouring, and torch-cutting procedures of metallurgy emit metal particulates containing lead, cadmium, and nickel.

In cold and temperate parts of the world, domestic coal burning has been a major contributor to the particulate content of urban air and traffic-related emissions may make a substantial contribution to the concentration of suspended particulates in areas close to traffic. Very few filters are able to remove these contaminants and they easily become part of the indoor air supply through a building's ventilation process. Once in the air they stay suspended indoors for long periods of time, and are breathed in by inhabitants, where they do damage to the human body.

Outdoors these particulates are removed through rainfall. FIG. 6 contains two photos showing a city scene before and after a rainfall, and the difference that this produces in relation to airborne particulate matter.

However, within a building rainfall does not occur and so other means have to be found to remove them. Plant air purifiers can accomplish this task, but they do even more. First they pull indoor air through a moist filter bed where these particulates attach themselves to moisture droplets in the filter and then plants growing within the filter bed draw these same moisture droplets containing the particulate matter into themselves through their roots, retaining the particulates within their cell structure. Then they emit the remaining moisture through stomata in their leaves in a process known as transpiration, The particulates then are concentrated within the body of the plant, and some serve as a store house of nutrients for future growth of the plant, since many are composed of nitrates, sulfates and carbon which serve as fertilizer for plant growth. In some cases some of these particulates are heavy metals which the plants have mistaken as nutrients because of their similar shape and makeup. These simply remain within the plant and so protect humans from breathing them in. This uptake process, which the plants engage in, is known as mass flow and it removes particulates matter from indoor air. Were the plant air purifier and the plants within not to absorb these particulates, people would breathe them and harm would result. Plant air purifiers prevent this from happening.

These particulates if not removed from the air can cause stroke, diminished lung function, can worsen asthma, and can cause COPD inflammation. They cause greater use of asthma medications and increased rates of school absenteeism, emergency room visits and hospital admissions. Some of the other adverse effects caused by particulates include coughing, wheezing, sneezing, runny nose and shortness of breath. They also give rise to cardiac arrhythmias, heart attack, cancer and cause reproductive and developmental harm, as well as increase diabetic risk.

Any of these, if suffered by a member of an employer health care group or any health care group or pool will increase a group health plan's costs. As long as plant air purifiers are supplied to all members of a plan costs should be contained and so result in smaller increases in premiums in the future. Having a plant air purifier as an add-on to an insurance plan should definitely contain costs and can be very cost effective.

A number of health insurance programs include some form of prevention or wellness as part of their overall program and some are set in the Affordable Health Care Act. Presently eighty-one percent of companies with more than 50 employees have some type of wellness program according to the Wellness Councils. And sixty-five percent of firms offering health benefits offer at least one of the following wellness programs: weight loss programs, gym membership discounts or on-site exercise facilities, smoking cessation programs, personal health coaching, classes in nutrition or healthy living, web-based resources for healthy living, or a wellness newsletter. Yet wellness is hard to define and a wellness program may include anything which adds to the health and wellbeing of those involved.

Most wellness programs put their emphasis on bringing forth a change in lifestyle, asking someone to exercise more, smoke less or drink and eat less. If successful these lifestyle changes take a long time to eventually become habit and recidivism is quite high, especially since many are addictive behaviors. In addition food makers have switched the types of sweeteners they use which makes it all the more difficult to stop binging, for they now utilize high fructose corn syrup, as the major sweetener which actually bypasses the brain's capacity to tell when a person's body is full causing people to just keep eating. This makes it all the more difficult to stay trim. Change of life style is difficult to achieve to say the least. Further, many who have unhealthy habits are unwilling to change in the first place. Nor can corporations easily fire those that have such habits, not without risking being sued.

Thirty states and Washington, D.C., have laws against firing or demoting smokers, while. California, Colorado, Tennessee, and North Dakota have laws specifically restricting employers from forbidding any legal activity a worker does off-hours. As for firing those who are obese, while only the state of Michigan and six U.S. cities make it illegal to fire someone, or not hire them, because of their weight, the U.S. Equal Employment Opportunity Commission (EEOC) now claims obesity is a disability under the Americans with Disabilities Act Amendments Act (ADAAA). Further, when President George W. Bush authorized the ADA Amendments Act in 2008, the law's threshold was lowered substantially.

Meanwhile, jurors are favorably disposed to plaintiffs who bring suit based on any form of discrimination related to life style as evidenced by a Yale study published in 2010 which showed American attitudes on the subject. In it was shown that a majority of Americans would support legislation that would prohibit weight discrimination in the U.S. with most people opposed to discriminatory practices such as refusing to hire, withholding promotions, paying lower wages, or unjustly terminating obese employees,

Women were more likely than men to say weight discrimination ought to be illegal. While less than half (47 percent) of men said they would support adding “body weight” as a protected category to existing Civil Rights law, though 61 percent of women thought it was a good idea. Also it was found that 65 percent of men said they would support laws to protect obese employees in the workplace, while 81 percent of women wanted to see such protection. As a result while such laws for protection of overweight people may not be on the books, jurors will undoubtedly lean favorably in the direction of the plaintiff against corporations trying to weed them out and will use any reason they can find to award them damages.

Further it is also possible that firing, refusing to hire or other practices penalizing employees because of their weight could result in a claim of discrimination based on another protected characteristic, such as age. Back in the day when flight attendants had weight restrictions they had to maintain, the argument was made that such a requirement had a disparate impact based on age, because as women age just as men they become heavier.

Actual cases show a jury awarded $284,000 to a man who claims he was fired from his job for being fat where the eight-person jury in U.S. District Court awarded the money in a wrongful discharge discrimination case against Continental Rental, Inc. So changing of lifestyle can be fraught with danger.

As we mentioned earlier almost two thirds of all health care costs for an employer group health plan are spent on just 10% of employees within the plan and usually these have chronic illness. People who are chronically ill—who run up the biggest medical bills to a plan—are often depressed which carries with it its own set of problems, one of which is that many people with depression produce a higher-than-normal level of the hormone cortisol which suppresses the immune system. In addition depressed people are least liable to want to change, at least voluntarily, since to them eating, drinking, and smoking are among the few remaining pleasures left them in a world with intolerable choices and where they find themselves in an intolerable situation because of a job they don't like, marital or money problems, outright discrimination because of their habit, or health problems. In addition a high percentage of these people are suicidal or have suicidal tendencies and they are looking for a way out and just changing their habit is not going to solve their problem. Some of the chronically ill see sickness and eventual death as a way out, and a socially acceptable one at that.

Wellness programs may be instituted through government policy, they may be undertaken by business but whether they will receive wholehearted corporate support is questionable. This is so especially since they do not produce immediate profit to the organization, or immediate savings above the cost of the program itself. For big business, or those where most wellness programs are undertaken, the desire for the program is to save money on the health costs of their employees, to increase productivity and to provide a showcase to attract younger workers who will work longer hours and work for less. Having a new gym within their headquarters provides them with such a showpiece and is helpful for recruiting purposes. Dealing with addictive behaviors is not something they look forward to doing and there are surely easier ways for them to make money. Further success with a wellness program takes time and for a business that wants to show improvements on next quarter's balance sheet, this will not bring quick results.

The history of wellness programs has demonstrated that such programs usually take three years before they overcome their costs and in the first year costs are usually higher than the year before since screening of employees with a physical exam, as most wellness plans call for, may alert some members to a chronic condition which requires immediate treatment, thus upping cost instead of lowering it. Further, since the average employee spends a mean time of 4.4 years at a particular corporation before he moves on, instituting a wellness program often only provides a free lunch for the next employer who will receive the lion's share of the benefit and most businesses are not so altruistic.

Finally, few businesses will devote the money and attention necessary to ensure the success of a wellness program if the improvement that results in their particular employees' health status is watered down by lumping that particular company's employees in with a much larger group of employees, or pooling them with employees from many other companies, as is the case for most health insurance programs where the corporation does not self-insure.

Pooling is a way in which insurance companies mitigate risk, by lumping the healthy with the sick and by assuming that a given number of them will come down with some form of chronic illness on a yearly basis. Risk management occurs by looking at large population health statistics and by forming smaller groups into larger groups, so as to smooth out unusual occurrences and unusual pay outs which might entail actual loss.

However pooling limits the benefit that any one smaller group receives if it is amalgamated into a larger group and dedication to wellness may vary. That is why mainly only single large groups whose individual populations are large enough institute wellness programs in the first place. Nobody likes to work hard while a bunch of slackers share in the benefits from their hard earned efforts, while the rest contribute nothing to the group as a whole. Unfortunately the practice of pooling helps to subsidize irresponsible behavior and forces responsible people to pay more for health insurance so that irresponsible people can pay less. Pooling is a true disincentive for companies if they would aggressively institute a wellness program. This disincentive is presently built into small employer health insurance programs.

This is not to say that wellness and prevention programs cannot be effective, but they must fulfill a number of requirements. They must provide a corporation with an immediate return on its investment in wellness, the program should have full participation on the part of all covered in the plan, resistance on the part of members should be eliminated, lifestyle changes should be minimized so there is no addictive behaviors to overcome, pooling should only occur where all companies in the pool have the same incentive and motivation, or device, to drive down costs. If the program can provide a showcase such as a new gym for business, or provide something physical which puts the company in a good light and improves its image, so much the better. In addition the program should improve employee health, not cost very much, and be able to document savings. If it can do all these things business will be very receptive to such a program.

The health insurance program our method patent offers, which incorporates plant air purifiers in the workplace and the homes, provides all these benefits and additional benefits besides.

But before we look at the program or the rider to a health insurance policy which we propose, it is important to look at what the plant air purifier deals with as opposed to what other wellness or preventative health insurance programs have tried to deal with in the past.

In the case of the normal wellness program, there is an effort to restrict substances abuse, which Americans normally ingest orally or through the lungs, and which cause harm to the body, such as alcohol, cigarette smoke and certain unhealthy foods—all of which have been laced with chemicals, or modified in such a fashion that they have been stripped of their nutritional value and altered in such a way that the body finds them hard to digest or expunge. Plus these wellness programs emphasize exercise as a way to trim down fat and burn off and expunge the harmful residue of this ingestion of unhealthy substances. Further these programs are based on the concept that if you know how dangerous your actions are you will change them. In other words, most wellness programs rely on individual choice, on the part of the members within a health group, to lower health costs.

Our program, on the other hand, seeks to remove harmful pollutants found in the air which we involuntarily breath in, whether chemical, radioactive, or biological—waste products from manufacturing, energy generation, from off gassing of materials within our structures, from natural elements which creep into the structure from the ground below, from pollen and germs, viruses and flu, pollutants and irritants, carcinogens and toxins we have no choice as to whether we take in, since breathing is an involuntary act, one we have no control over. For humans must either breathe or die.

Now what does that mean for a health plan, where breathing is concerned and air purification is used to lower costs? It means that when plant air purifiers are placed in the workplace or home, we do not have resistance, conscious or unconscious, on the part of any member of the plan in benefitting from the purification process. No one opts out and there are no addictive behaviors to overcome. Nor do we have to provide incentives to induce members to participate, or is a change in lifestyle necessary, since people were breathing previously and will continue to breathe now; nor is extra effort required or does inertia have to be overcome as with whether to exercise or not. In fact with air purification less effort may be required, especially for those who found breathing difficult, who suffered from asthma, COPD, or pulmonary disorders, for now they may well find it easier to breathe than ever. One of the main advantages to using air purification as a method of reducing health costs in an insurance plan is that all will benefit if an air purifier cleans the air in the immediate vicinity of where the person is. This is a considerable advantage over wellness plans now in existence, for now choice simply does not enter into the equation. Nobody will “fall off the wagon.”

One might well wonder why air purifiers have not been included previously in a wellness program. They were not so included because most are ineffective. They simply do not remove all contaminants. But the discovery of the plant air purifier by NASA changed all that. Now there was a way to remove all of the different types of pollutants normally found in air with a single unit. It did so by including a growing plant(s) and symbiotic microbes, which live around the plant's root system within its filter bed. These digest contaminants—VOCs, bacteria and hostile microorganisms, as well as certain particulate matter such as dust and pollen—and encapsulate others, such as radioactive elements and heavy metals.

A plant air purifier's filter bed, composed of artificial soil, is extremely porous and allows great quantities of air to pass through it easily, propelled by a blower or induction fan, which forces contaminated indoor air through the filter bed where it is purified. Plants were always known as air purifiers but now with the NASA design which increases air flow moving through the filter bed, a single plant can purify as much air as it would take a hundred plants to purify previously. And with fewer plants less space is needed, thus leaving enough room for both plants and humans to exist comfortably within a structure which previously was impossible. Plant air purifiers remove toxins within a structure before inhabitants breathe them in and so mitigate against the danger of disease which they cause. They will reduce chronic illness on the part of those within the group and provide welcoming relief to the chronically ill already in the group as well. As shown in FIG. 7, further studies have shown that the chronically ill who suffer from pulmonary ailments are among the largest group of chronically ill in the country.

Plant air purifiers overcome many a difficulty faced with regard to the inhalation of toxins and by our incorporating these devices in our offices and homes by way of an insurance product they will ultimately lower health insurance premiums. It is just that simple. Meanwhile the effectiveness of these units has already been demonstrated. Through studies conducted both by NASA, the EPA, the New York State Energy and Research Authority and Syracuse University, just to name a few.

### SUMMARY OF THE INVENTION

Disclosed herein is a method in various embodiments by which health costs of a business entity, fraternal organization, municipal government or agency or the federal government or any of its agencies are reduced by the utilization of plant air purifiers to clean indoor air where employees, members or insured are so located either during working hours or after hours and that either the purchase or lease of said air purifiers are obtained or said air purifiers are supplied through an insurance company, a supplier of these devices to an insurance company, a supplier of said devices who sells to a companies or organizations, or a business entity which caters to the health insurance or health maintenance needs of an organization so mentioned above and that said supplier also uses a computer to keep track of those plant air purifiers dispensed.

Specifically disclosed and claimed is a method by which an organization with plurality of employees and/or insureds and/or members takes steps intended to reduce its costs for providing healthcare, by establishing a wellness and prevention program which comprises at least one of the following: paying for costs of installing plant air purifiers in a workplace of said employees and/or insureds and/or members; paying for costs of installing plant air purifiers in places of residence of said employees and/or insureds; wherein: said plant air purifiers include a mechanism for forcing air to pass through a filter bed thereof in which said plants are rooted.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a graph illustrating costs for medical treatment in various countries during the period 1970 to 2007.

FIG. 2 is a map showing the geologic radon potential of the United States.

FIG. 3 is a map showing the prevalence of current cigarette smoking in the United States among adults aged 18 years and older, by state, from the Behavioral Risk Factor Surveillance System, United States, 2009.

FIG. 4 is a map showing states with the highest incidence in chronic illness.

FIG. 5 illustrates the relative sizes of various particulates which can be inhaled by humans, in relation to a human hair.

FIG. 6 contains two photos showing a city scene before and after a rainfall, and the difference that this produces in relation to airborne particulate matter.

FIG. 7 is a chart showing the number of people reporting selected chronic diseases in 2003.

FIG. 8 is a photograph of a large plant air purifier.

FIG. 9 is a plan view of a plant air purifier within an atrium.

FIG. 10 is a photograph of a free-standing plant air purifier.

FIG. 11 is a photograph showing plant air purifiers resting on a floor and hanging from a ceiling.

FIG. 12 is a photograph showing a large wall-mounted plant air purifier.

FIG. 13 is a plan view showing a wall-mounted plant air purifier.

FIG. 14 is a plan view of an uninhabited space in the basement of a commercial building.

FIG. 15 is a plan view of plant air purification enclosure installed in an uninhabited space in the basement of a commercial building.

FIG. 16 is a plan view of a double light system which increases UV light killing power by 1000 times.

FIG. 17 is a plan view of a mobile plant air purifier enclosure hooked up to a building.

FIG. 18 is a photograph of a plant air purifier made to look extremely attractive in appearance.

FIG. 19 is a photograph of a plant air purifier made to look like a pedestal and urn.

FIG. 20 is a photograph of a small portable plant air purifier.

FIG. 21 is a photograph of a small portable plant air purifier made to look and watered like a regular houseplant.

FIG. 22 is a plan view of a plant air purifier which has its own reservoir with a pump to automatically moisturize the filter bed when needed.

FIG. 23 is a plan view of an intelligent plant air purifier.

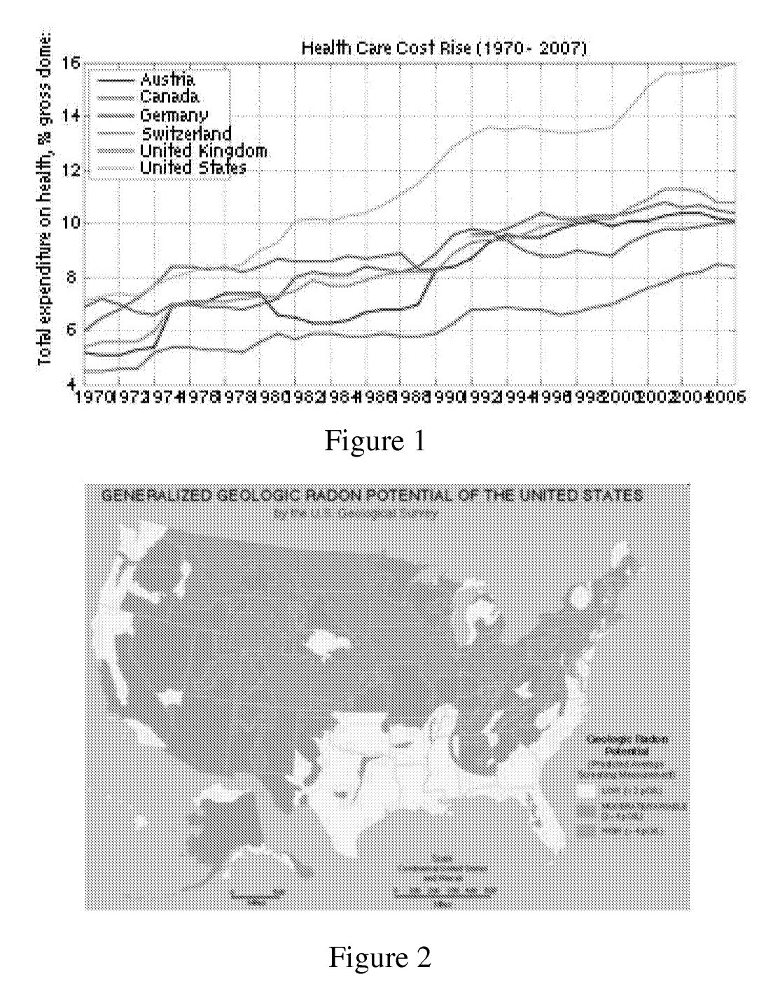

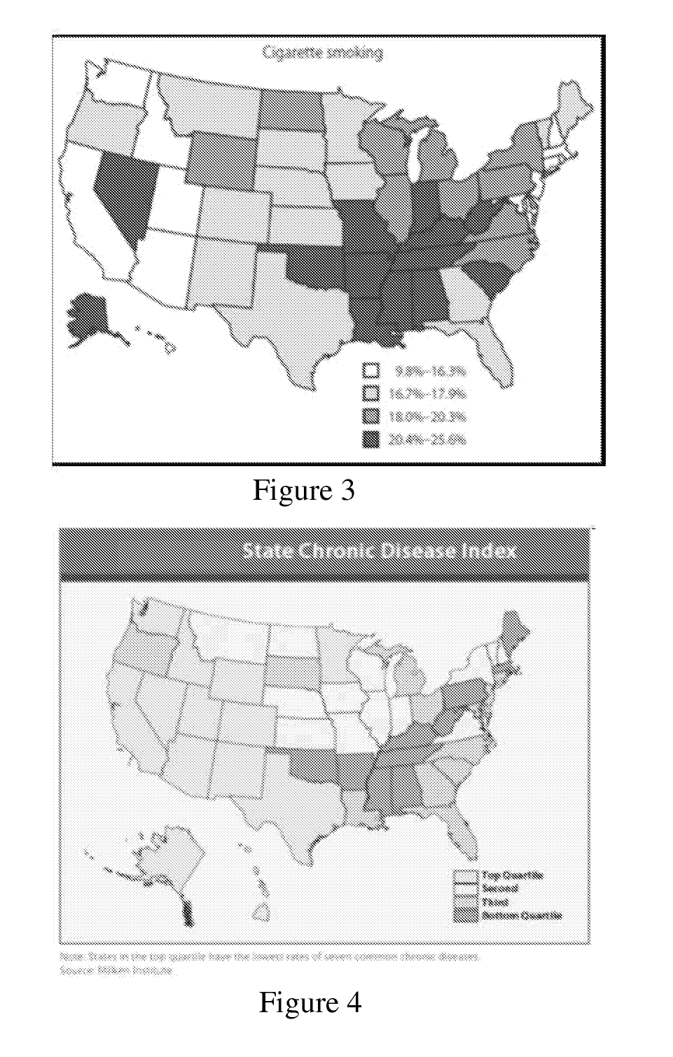

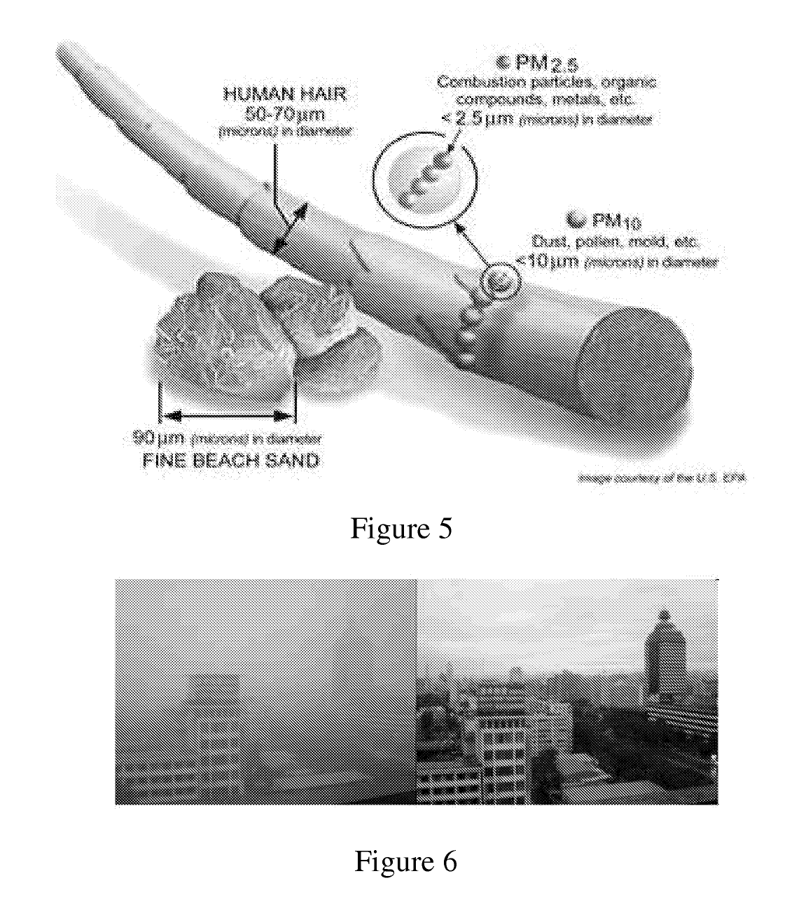

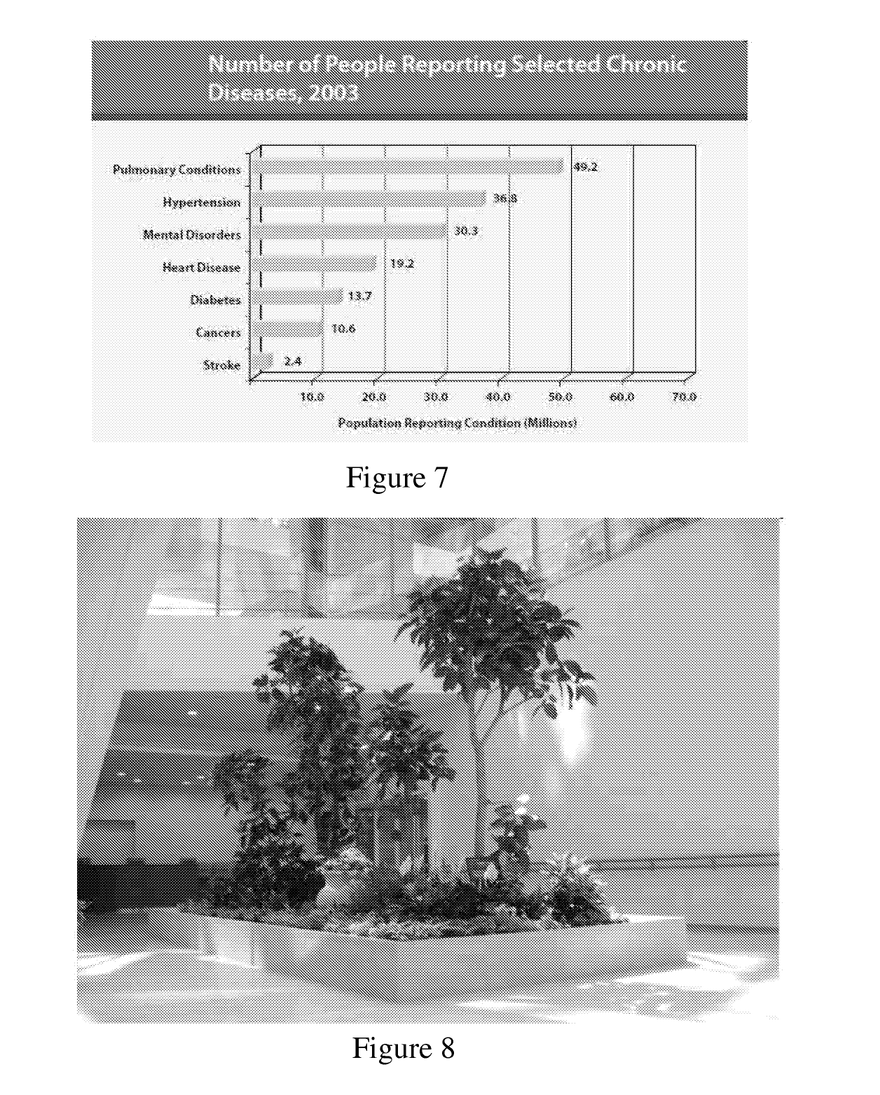

### DETAILED DESCRIPTION

What we propose in this disclosure is a health insurance rider or health insurance policy where insured members receive the benefit of plant air purification. Where units are installed, either in their place of work, in their homes, or both, so that almost every breath they breathe has airborne pollutants removed from the indoor air around them before they ever breathe them in. Further the program can also provide a charge for maintenance and upkeep of these devices as well.

(It is to be remembered that living entities reside within the plant air purifier and these require sufficient nourishment, appropriate temperature, adequate light, dusting of the leaves, pruning on occasion, examination to see there is no insect infestation, adequate moisture with limited or no chemicals such as chloride or chloramine which friendly microbes within the plant air purifier would find harmful to their existence, and limited attention. Plus checking might be necessary to see that mechanical components of the unit do not need replacement. Failure to meet these basic requirements will result in the death of the plants and the microbes in the plant air purifier which will then necessitate replacement. If this is not done or if malfunctioning mechanical components in the unit are not attended to, this might well limit the unit's effectiveness and impair its ability to purify the air, which will then result in harmful pollutants being inhaled by members of the insured group and so raise medical costs.)

The program will also have a computer monitoring system which keeps track of some or all of the following: when the units were last attended to, how long units have been placed with the group, leasing costs of the units, maintenance cost for the units, what was the member's medical history, their number of visits to a doctor, their prescriptions and the cost of those prescriptions, their last time they went to the hospital or the emergency room, how many times they went in the past year, and the year before that, how many days they were absent from work, how long they have worked for the organization, when was the last time they collected unemployment insurance or disability insurance, their gender, their age, whether they have single insurance coverage or family coverage. If they have family coverage each dependent within the plan should have his or her medical history also recorded as well. For covered dependents in the plan, their information should be included, plus how many days those people missed school or what conditions they have. Also there could be an overall figure for each of these categories for the group as a whole so that the past record of performance and cost can be compared with previous years as a means of tracking performance improvement. Ideally this computer capability would plug in with the already existing computer capability of the insurer or the company for easy update. Thus there will be a means of finding out just how cost effective use or lease of the units are and which illnesses they were most effective at dealing with.

Charges for use of the devices, installation of the office units and removal and maintenance can either be attached to the already existing policy as a so called surcharge or the firm or an independent party can pay for these as long as it can share in the benefits that accrue such as any health insurance premium rebates, fewer sick days benefits, less unemployment compensation claims or disability claims, or if it were to lower the average health insurance premium increase in future years.

There may also be an inclusionary provision whereby if an organization or health plan incorporates plant air purifiers within its program and if they lease such units for less than a certain period of time they may not cancel the lease and purchase plant air purifiers in place of leasing them from our group or the particular insurance group for so many years.

Large organizations which are self-insured are not faced with a pooling worry where the benefit of improved health through the use of the plant air purifiers will not be watered down and shared amongst those not using these devices. But in the case of smaller employer groups which will be amalgamated into a pool, the pool should only contain those other employers and its members that use plant air purifiers, as these devices are expected to cut down on chronic illness and the expenses that treatment, prescription, hospital visits, as well as doctor's visits would cost a group or individual health plan.

These devices in the most ideal of circumstances should be supplied for both the home and office of the insured members of a group so that the air an insured breathes, almost all hours of the day, will have plant air purifiers cleaning that air. Since humans in America spend almost 90% of their time indoors and a large percentage of that time in their home and work place, as compared to other places, they will have better protection.

In these discussion following we shall review multiple Figures which are photographs of plants and planters in a variety of configurations. These are NOT photographs of plant air purifiers of the nature covered by this disclosure which include forcing of air through the filter bed in order to purify air using the microbes associated with the plants' root systems. Rather, these are photographs of ordinary plants and plant collections in which the preponderance of the air purification occurs via carbon dioxide absorption and oxygen emission through the plant leaves. This is only a fraction of the purification that is made possible by a plant air purifier with air forced through the soil. The point of all of these photographs is to highlight that the forced air system used for plant air purifiers covered by this disclosure can be largely or completely hidden from view, such that a plant air purification systems as intended by this disclosure can be made to appear just as do the plant system in these photographs, but can as a matter of utility be made orders of magnitude more effective for producing clean air than the plants and planters in these photographs. In other words, these photographs illustrate how the plant air purifiers envisioned by this disclosure can be made to appear, but does not suggest and should not be taken to suggest that such systems are already deployed in this manner as part of the prior art.

The foregoing is important in gaining market acceptance, because the ability to provide a much more effective way of cleaning air without having to intrude upon or compromise visual appearance or infringe upon exiting space with unsightly machinery is very important to gaining acceptance for this technology. The other key penetration barrier is to simplify use and maintenance to that the use of plant air purifiers comes as close as possible in terms of costs and maintenance and attention as preexisting mechanical air purifiers.

As shown in FIG. 8, large units can be supplied which can be built into the work place or home so as to appear spectacular or simple.

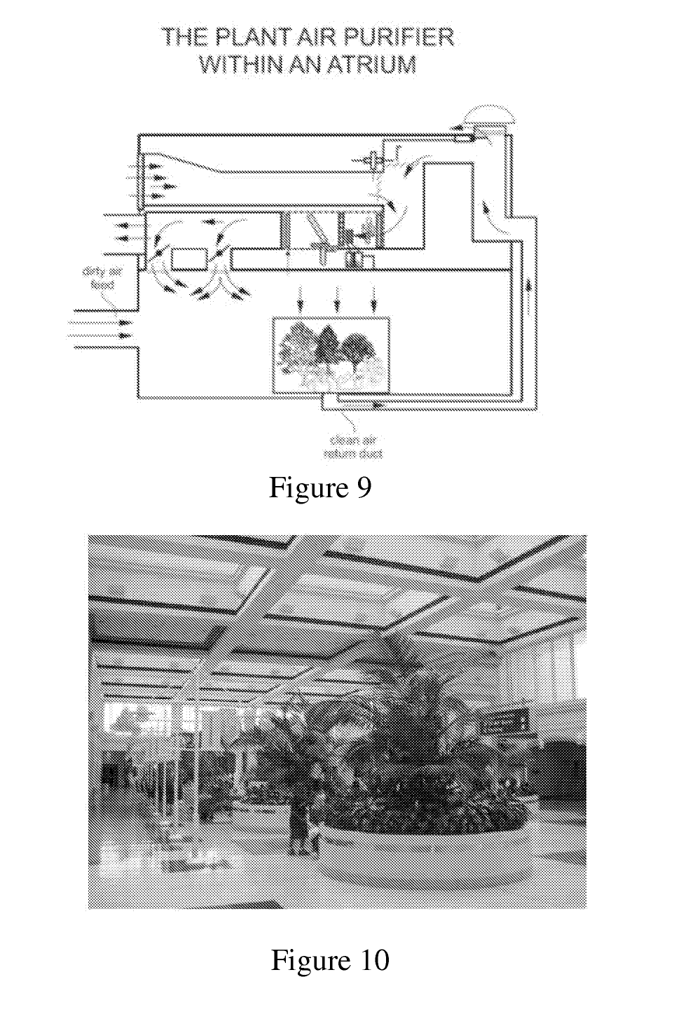

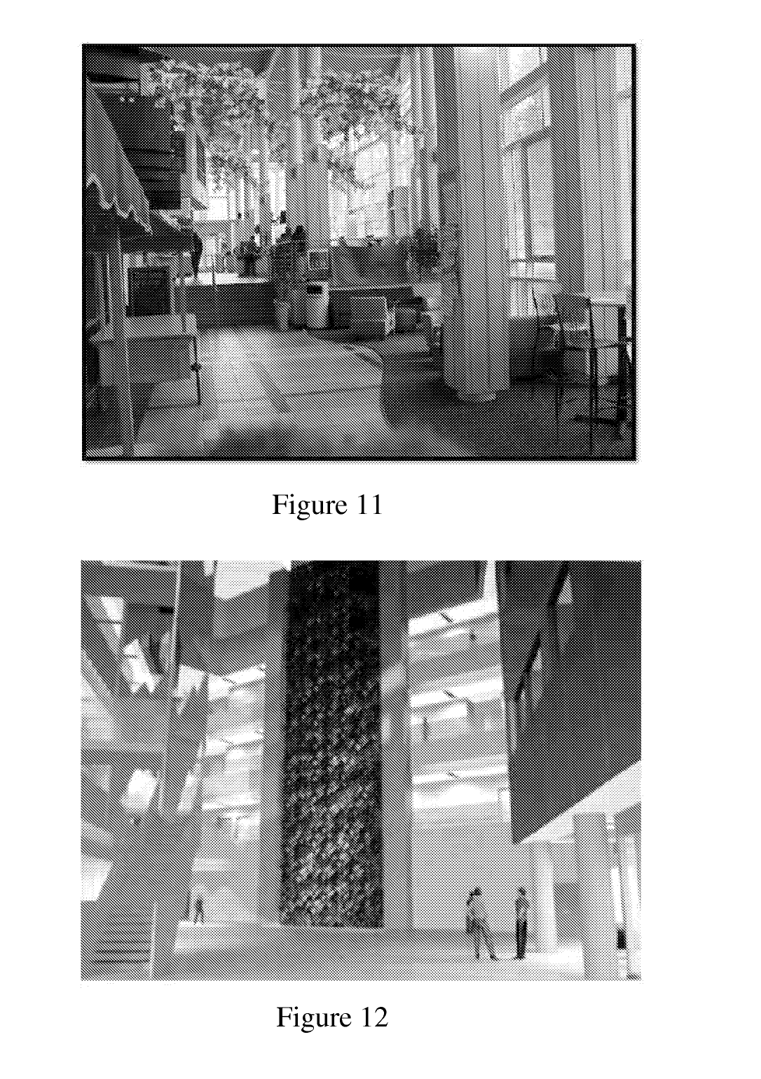

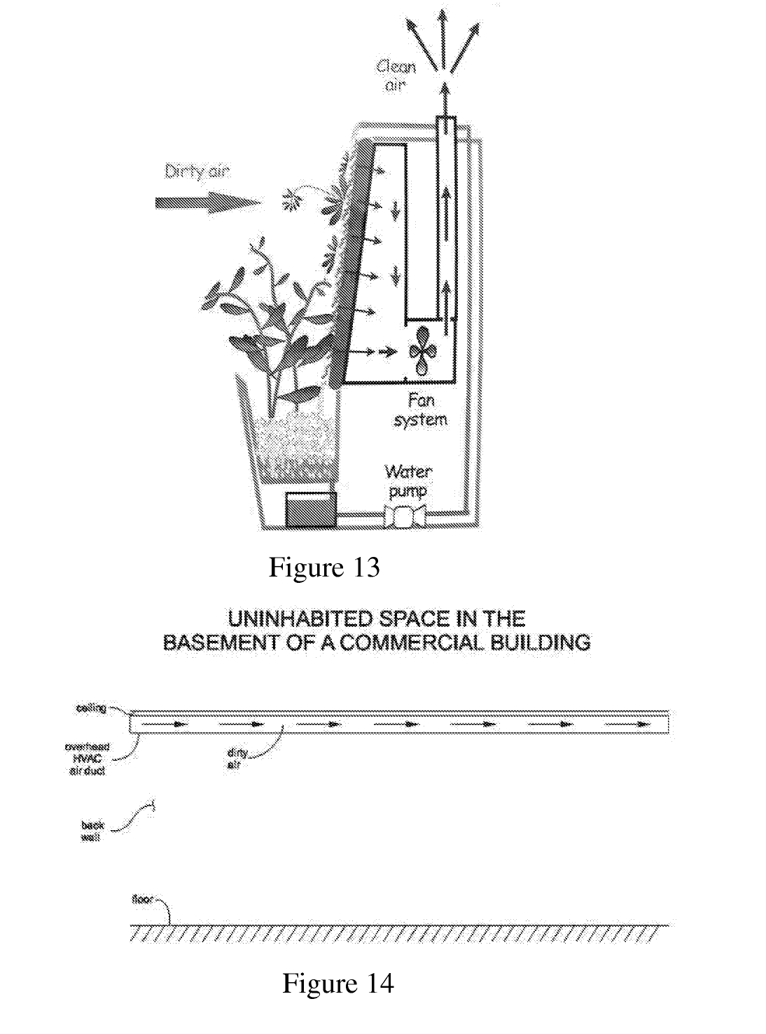

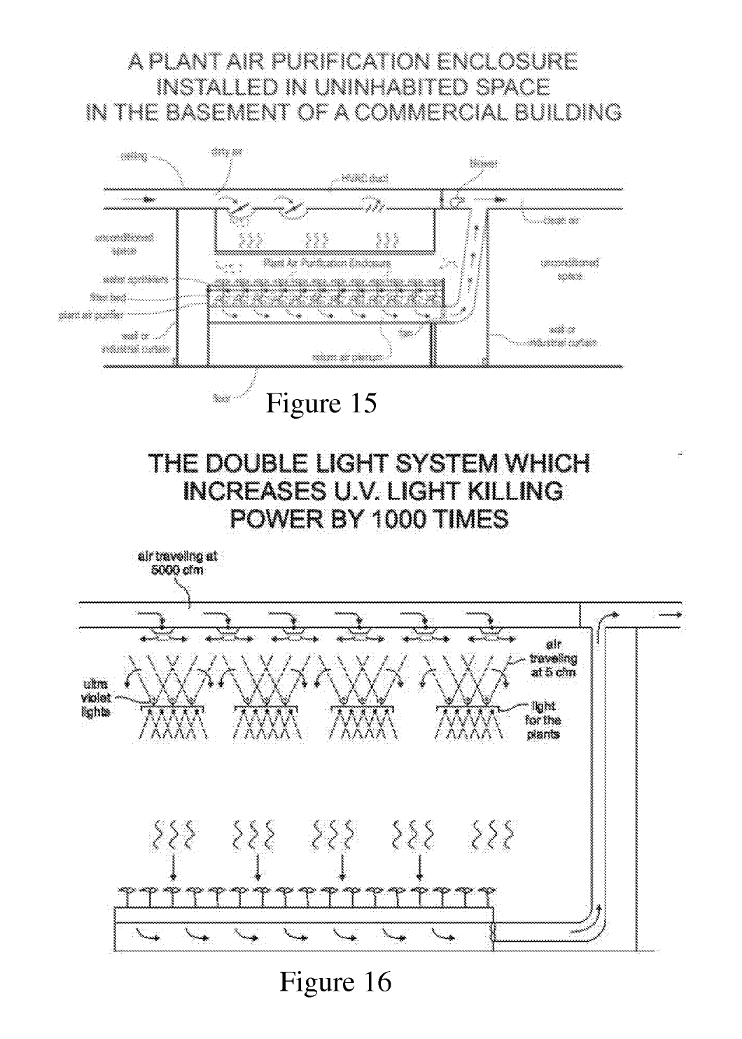

As shown in FIGS. 9 and 10, these can be connected to the building's HVAC system or be free standing, where air simply returns to the area in which the unit is found. In some cases they can be placed in areas where customers as well as the insured enjoy the benefits, as in a shopping mall, airport, or big box store. They may rest on the floor itself or hang from the ceiling, as shown in FIG. 11. If they hang from the ceiling, they can be lowered when maintenance is required, and so take up no additional space. As shown in FIG. 12, and in plan view in FIG. 13, they can even be wall units if that is desired. They can be placed within the habitable space of a structure, or placed in space which is normally uninhabited, as in the basement, see FIG. 14, where people utilizing the building never know they are even there. As shown in FIG. 15, if placed in uninhabited space, airflow speed within the space can be reduced and as shown in FIG. 16, the killing power of ultraviolet light can be increased by as much as a thousand times, which will have a tremendous effect on airborne germs or viruses within the air itself. This is tremendously important in certain environments where germs can be a problem as in a hospital or lab.

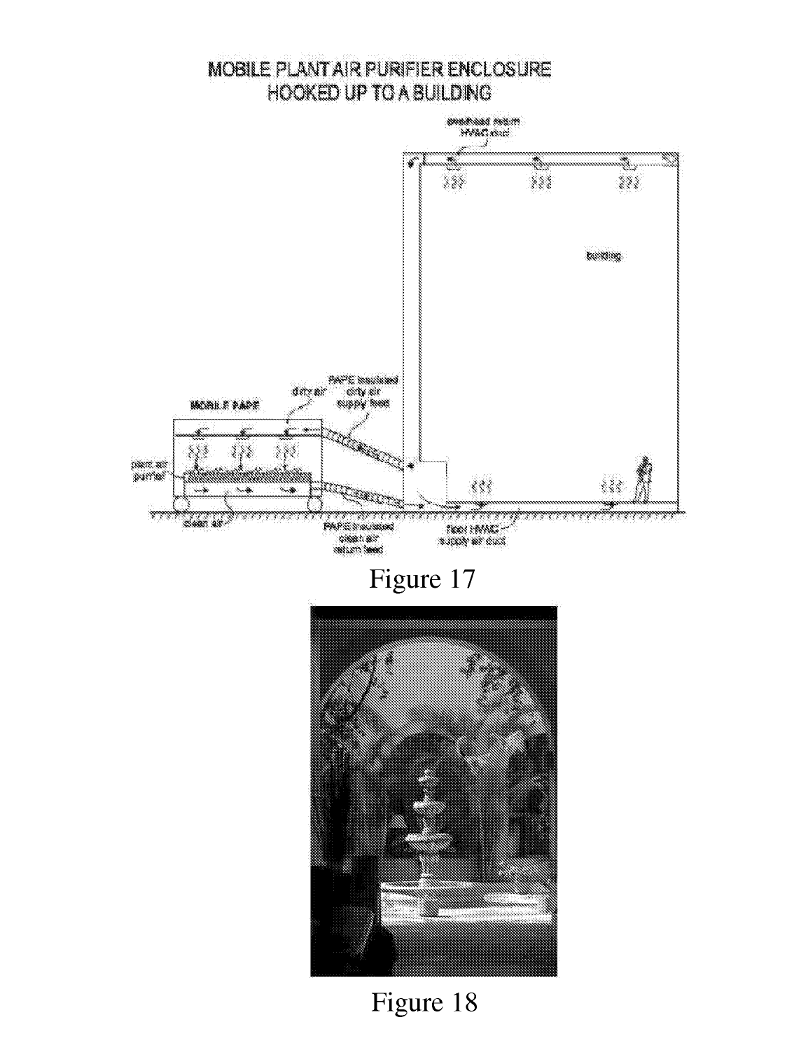

Plant air purifiers can be placed within the building as shown previously, or as shown in FIG. 17, may be placed outside the building itself, where they can actually be driven up to the side of a structure and parked close by, then connected to a building's air supply, whereupon the mobile unit can then purify the air of that building.

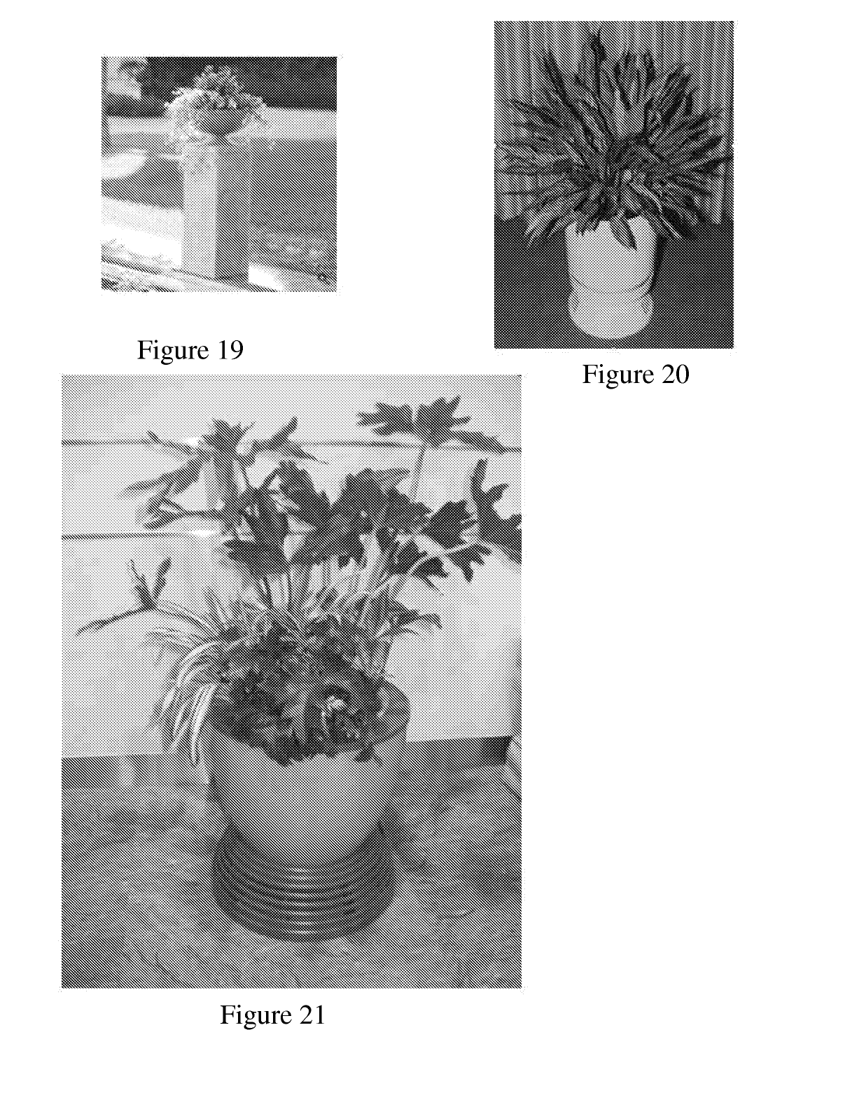

As shown in FIG. 18, plant air purifiers can be made to look as spectacular as someone would want. They can be equipped with a fountain, or as in FIG. 19, may look like a pedestal and urn, which would add to their attractiveness if placed in a restaurant, casino, or hotel lobby. Or they could be made to look very unobtrusive.

While larger units would be able to handle the needs of many as in an office environment, small portable units with appearance such as shown in FIG. 20 would also be available which could be placed on a person's desk or close by their work station, or could be in an insured's living room at home, or by their bed, or even next to a child's crib.

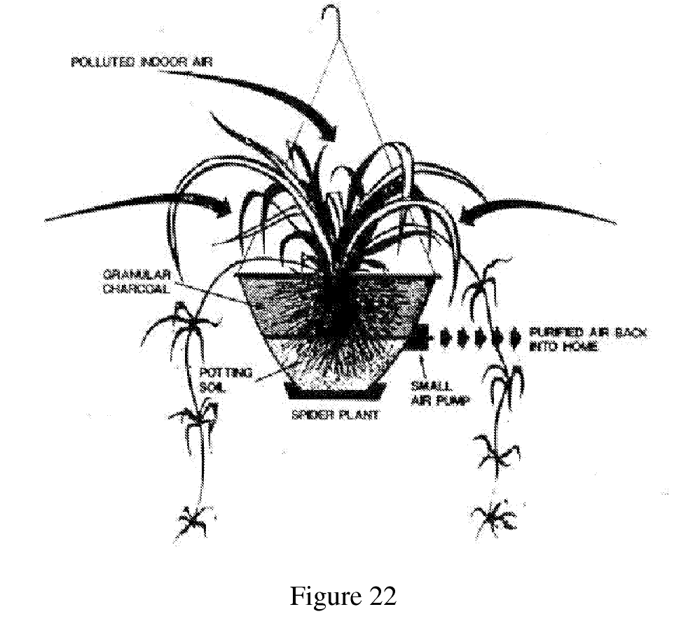

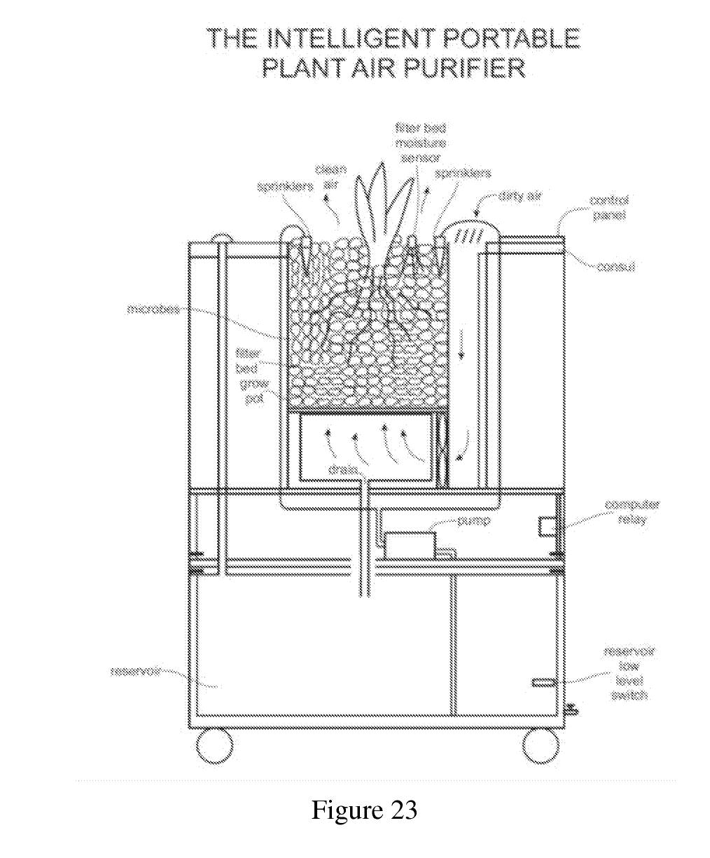

As shown in FIG. 21, these portable units could be of a simple design and made to look and watered like a regular houseplant, or as shown in FIG. 22, may have their own reservoir with a pump which would moisturize the filter bed when needed automatically. In addition, they can be directly hooked into the water supply of the building or the person can manually water. Meanwhile units, large or small, could be on casters or rollers, to allow for them to be easily installed or removed, as illustrated by the intelligent portable plant air purifier of FIG. 23. Anything that minimized maintenance and automates use contributes to market acceptance and penetration.

As for air purification's cost effectiveness, studies have shown its benefits far exceed its cost. In fact in a study entitled Estimate of an economic benefit from investment in improved indoor air quality in an office building by P. Wargockia, and R. Djukanovica, conducted by the International Centre for Indoor Environment and Energy, Technical University of Denmark found life-cycle costs of investments for improving air quality in an office building when compared with the resulting revenues from increased office productivity (in which benefits from reduced health costs and sickness absence were not included) resulted in productivity benefits being up to 60 times higher than the increased costs.

Other studies have shown that benefits while not quite so high, still produce increased productivity of at least 5% or more, which when one computes the dollar benefit to an employer of such improvement, for the average office worker who costs a company better than $50,000 a year in salary and benefits, comes to a $2,500 a year bottom line improvement to the business. Some of this can be measured in higher worker productivity, lower absenteeism, fewer sick days taken, lower unemployment insurance or disability insurance and of course lower health insurance premiums. Truly improved indoor air quality pays for itself.

It is anticipated based on current projections that the installation of plant air purifiers in the workplace and home of employees should run about $240 a year per employee and about $60 a year for each additional insured in a family plan, or extra unit for the home. This is a small price to pay when “the average premium for single coverage employer health plan coverage in 2011 was $5,429 per year, while the average premium for family coverage was $15,073 per year, as reported by a Kaiser Family Foundation and Health Research and Educational Trust report. Further this cost of leasing plant air purifiers is not at all that much higher than some gym member subsidies given to employees by an employer where businesses have wellness programs and where the firm pays $20 a month toward an employee's gym membership and an additional $2 administrative fee, if he or she makes use of such services a certain number of times a month.

The installation of plant air purifiers can also result in lower heating and cooling costs for the business as well. A 3 year $450,000 study conducted at Syracuse University proved this conclusively. This study was funded by the EPA, the New York State Energy and Research Authority (NYSERDA) and Phytofilter Technologies, Inc., and is titled NYSERDA report: Air Cleaning Technologies for Indoor Air Quality (ACT-IAQ): GROWING FRESH AND CLEAN AIR, final report December 2010, No. 11-10, and can be found at http://www.phytofilter.com/NYSERDAREPORT.pdf

In the study a plant air purification device was installed for experimental testing in a building on the Syracuse University campus and resulted in a savings of 26% on heating costs and 10-15% savings for both heating and cooling overall. Since plant air purification cleans indoor air internally, ventilation needs can be reduced by 80% or more. With fewer air exchanges, heating or cooling of outside air, which has to be brought in to replace the air expelled, is now lowered and fuel consumption drops. This lowers a company's carbon footprint and makes for a green installation which increases a firm's image. All of this is at no additional cost.

For any business which owns or leases its own building or which separately pays for energy needs for heating and cooling of a structure plant air purification can save considerably on fuel costs and this benefit alone can offset as much as one third of the yearly expense of including plant air purification in a group health insurance plan such is disclosed here.

Another benefit an employer enjoys from having plant air purifiers included in a health insurance program is that it increases employee morale. Various studies have shown that quality of indoor air is high on the priority list as far as employees are concerned and that since a large percentage of the population suffer from heightened sensitivity to chemicals and mold, having plant air purifiers in the workplace will go a long way to allaying any concern and insulate an employer from a possible IAQ lawsuit. Since IAQ lawsuits have been on the rise since 1999, limitation of this possible costly occurrence is a plus. In addition, having such units will increase the ease of breathing for employees who suffer from allergies and asthma or from multiple chemical sensitivities. It has also been shown that having plants in the office also reduces stress.

Also for those who are enrolled in family coverage within the employer's group health pan there is nothing more heartrending for a parent than to see their young child fighting for breath, as many asthma suffers often do. More than 50% of all asthma sufferers have had at least one asthma attack in the past twelve months. More than 8.2% of the overall American population suffers from asthma. Asthma is the most common chronic condition among children. Plus the number of asthmatics has been increasing, with the number of people with asthma in the United States having doubled in the past 15 years. More than 14 million school days and 14.5 million work days are missed annually due to asthma since when a child suffers from such an attack and has to stay home, usually a parent has to take off from work and stay with them.

With the program of health insurance disclosed here, plant air purifiers can be supplied to the home as well as the office. Even if a parent does not have family coverage a possible option would be that an individual can get extra units for their home if they are willing to pay the annual leasing fee that should come to about $60 a year per unit. Thus a parent can place a plant air purifier in the child's bedroom and so protect those who suffer from asthma, thus lessening risk of an attack.

Portable units have been placed in various people's homes for more than twenty years and here are some of the testimonials of various users who had a respiratory problem. These testimonials were supplied by Karen Jesse out of Cleveland who has more than a hundred pages of testimonials as to the units' effectiveness. She has placed over a thousand plant air purifiers in people's homes in the past fifteen years. These systems were very early prototypes of plant air purification systems envisioned by this disclosure and had numerous maintenance issues and lacked various sensors and intelligent hardware which facilitate ease of use and many other novel and nonobvious features that are disclosed in applicant's priority applications. Nonetheless, the health benefits are made clear by these testimonials. Their names and addresses have been removed so as to protect their medical confidentiality:

“I have asthma and allergies and it cleared up!”

“I have a chronic cough after five minutes near your unit it stopped. I don't want to get up.”

“It immediately relieved my bronchitis.”

“Feels like being beside a waterfall”

“I sat down with a stuffy nose and after a few minutes it was gone. This is fantastic.”

“Before coming to your booth, I was in the process of having an Asthma Attack and felt stuffy. Now I feel refreshed & am breathing much easier.”

“I am on medicine for a sinus infection. I could feel the air difference immediately.”

“I breathe much easier. I am just getting over pneumonia and Bronchitis.”

“I haven't been able to speak for the last month. I've been sitting by the plant for about 15 minutes. My sinus congestion is clearing and my voice is improving. In a few more minutes I'm sure I'll be able to talk a mile a minute. Watch out world—I've got a month's worth of talking to catch up on! My asthma is improving as well.”

“After sitting between two plant air purifiers I found I didn't have to use my inhaler.”

“I have slept thru the night every night for the few weeks we have had it. Also I don't cough and choke when I get up in the morning.”

“My fiancée and I live together with my cat and we both smoke. Every morning when we would wake up I would either have a headache, be stuffed up, or coughing like my lungs were full. Since we have had the plant air purifier I have not wakened stuffed up or coughing. Plus the number of headaches has decreased dramatically from 3 or 4 a week to 2 or 3 a month.”

“During allergy season, I am finally able to sleep at night without waking up all stuffy. No more wheezing through the night.”

“My staff and I never would have guessed that your air purification product make such a difference in the air quality of my office.”

“We had 7 smokers in the house. I have asthma and could not smell the smoke nor were my eyes burning. I recommend the plant air cleaner to anyone who has breathing problems.”

“About two months ago I decided to personally test a unique NASA spinoff device Air Filer. I used it in my bedroom since that is where my wife's allergic symptoms are most noticeable. Since turning the filter on, she has obtained significant relief from these symptoms, and as a result, she is sleeping considerably more soundly. I heartily recommend a plant air purifier to anyone affected by inhalant environmental allergies—and that means most folks with allergy problems.”

“Your air filter system has been a great success for us in solving our odor problem in the house caused by smoking, and outgassing from new carpet, furniture and paint from interior decorating. An additional bonus we enjoy is that plant acts as a humidifier, which enhances the comfort level of the room. Before this machine my husband would gasp for breath in between his snoring, causing me to have a restless night's sleep. Since we have run this machine he no longer gasps for breath as he sleeps.”

“Since using your system I only need to take my sinus medication very infrequently and rarely awaken with a headache.”

“My daughter was diagnosed with allergies. Once the air filter was put in at home there was a tremendous difference. My daughter began to feel much better and by the end of the week she was medication free and has been ever since.”

“David who was a champion snorer has become nearly silent at long last. It has eliminated those frightening moments when Dave seems to stop breathing, snores deeply and then starts breathing again. Peggy has also enjoyed an end to what we have always called ‘morning sickness,’ which is due to copious amounts of mucus being ingested during the night. Also she has not taken any allergy medicine since the day after the plant air purifiers arrived.”

“My husband has a chronic sinus condition. Also one of his ears has been blocked causing some hearing loss. After using the plant air purifier the coughs disappeared and he could hear again. What a relief for him. Still my husband was not a total believer of the plant air purifier and I loaned it to my in-laws to try. The cough is now back and his ear is blocked. Now he is begging me to bring the plant air purifier back home.”

“I've had hay fever allergies from birth and since I've been using the plant air purifier, my reactions have completely subsided.”

“I recently tested and evaluated a plant air purifier. Our business entity represents the sickest of the sick, always manifesting multiple chemical sensitivities, electromagnet frequency sensitivities, multiple food and inhalant allergies and an array of conventional medical diagnoses ranging from chronic fatigue, to depression, hypoglycemia, lupus, etc. Almost all clients are autoimmune, indicative of the inability of their immune systems to even remotely protect their bodies from routine, everyday encountered, airborne stresses. The plant air purification system is the most efficient user-friendly unit of my experience. It controls dust, mold, odors and other airborne inhalants that otherwise had remained untouched by our high-tech system. It is easy to care for and requires no cleaning or replacement of filters.”

“When we have to leave the house, particularly now that it is hay fever season, we can hardly wait to get back into the house where the air is clean and not health threatening. A purer haven to come home to is heaven.”

“A real surprise came this summer when a friend of ours visited with her daughter whose name was Tabby. Tabby had an allergy to cats and our friend was unaware we had one, not having seen us for a number of years. When they came into the house and into the living room the cat came strolling by and her mom said do you have any anti-histamines? Tabby is VERY allergic to cats and since I didn't expect to find one I don't have any with me. I told her that we did but would she mind experimenting with us. We quietly told her about the plant air purifiers and the benefits we had derived from them and she agreed to wait and see what happened to Tabby. We visited all afternoon and evening, including them having dinner with us and no reaction from Tabby. After dinner while we were chatting over coffee, Tabby sat and played with the cat. She told her mom she would like a cat like this one, ‘it doesn't bother me,’ she said. A few weeks earlier, they had stopped to see the mother's sister and the sister had two cats in the house and had put the cats out and kept them out for six weeks prior to the visit, knowing how sensitive Tabby was. To her dismay, Tabby reacted to the cats almost instantly when she went through the door!! This is a very big kudo for the plant air purifiers because it was unplanned and a real surprise. Again, we want to thank you for introducing us to these fantastic plants and we will keep spreading the word about them.”

“There are 4 smokers living in our apartment and the plant air purifier works great. It seems like the more pollutants there are the more the plant within it flourishes. When you first walk into the apartment, the smell of stale smoke does not exist.”

“I had cancer of the Larynx. Radiation makes my mouth dry. I was up every hour or two to drink water. My throat would be dry and caked from my sinus. With the plant air purifier I sleep all night. With a small amount of dryness. No sinus. Please give it a try.”

“We all know miracles happen every day that we do not see. This is a miracle to me for it has helped my seven month old grandson. For the past five weeks he has not had to use the machine for his asthma.”

“I had this cough for three weeks and my children had been sneezing continuously. Every morning I would wake up with a thickness in my throat, and by the end of the day I would lose my voice. After buying the plant air purifier, plugged it in and went off to work. That night I had the first peaceful night's sleep I had in three weeks!!! The thickness in my throat cleared up. Everyone stopped sneezing and I could actually SING IN CHURCH again!!!”

“As soon as I plugged in the system I noticed right away a difference in my breathing and sleeping. In one week I noticed my headaches were coming less often. My migraines were 3 to 4 a week, but after using this filter they went to 1 a week, and they were less severe. When I stopped using the filter I had this migraine and needed 9 sedatives in a 24 hours period just to release some of the pain.”

Another benefit that the employer may derive if they actually own the building which serves as a workplace if plant air purifiers are installed under a group health plan program is that with the plant air purifiers being installed in the workplace energy savings realized on heating and cooling may provide them with a tax deduction or make it that much easier to obtain a tax deduction for having an energy efficient building. Property owners can receive an immediate deduction for certain commercial building energy efficiency expenses, capped at either $1.80 or $0.60 per square foot, depending on the total efficiency level achieved. Commercial buildings placed in service before Jan. 1, 2014, may qualify for a deduction for the costs of energy-efficiency expenditures, capped at $1.80 per square foot. To qualify, the future energy and power costs with respect to interior lighting systems, heating, cooling, ventilation and hot water systems must be 50% more efficient than an otherwise comparable building based on the ASHRAE 90.1-2001 standard. A deduction capped at $0.60 per square foot is available for measures that meet a lesser standard (16⅔% more efficient than the benchmark comparable building). Since plant air purifiers have been shown to generate a 10-15% savings on heating and cooling, the 16⅔% threshold can be all but there and so the property owner can enjoy a depreciation allowance by installing a plant air purification system and making very minor additional upgrades. It is a win-win for the building owner who incorporates such a health plan with plant air purifiers into his business and structure.

Lastly there is an additional benefit to an employer in winter by having plant air purifiers, especially in the northeast, where the air in many buildings can become abnormally dry during winter months. This is because few commercial buildings have humidification, and when cold air, taken from outside is heated, the level of relative humidity drops drastically.

Normally humidifiers are not placed in buildings by building owners for good reason, since mold and mildew can start to grow in stagnant water within 12 hours which can give rise to many problems, health issues being amongst them. But since plant air purifiers remove mold spores from the air, actually trapping them in the filter bed of the plant air purifier where they are digested by friendly microbes within, mold problems are eradicated. And so inhabitants within buildings which have plant air purifiers enjoy a far more pleasant indoor environment and do not suffer from dry air, which can make their throat and skin feel dry and scratchy, cause or aggravate respiratory problems, dry out nasal passages and make people more susceptible to colds or the flu. Truly having plant air purifiers can provide the employer and the health plan set up for the employees and workers with many benefits.

To those knowledgeable in the art, variations in the manner of such insurance coverage with plant air purifiers may have other variations not mentioned but which are deemed to be included. And such insurance coverage may include individual policies offered by insurance companies or government agencies, or government insurers. Such a policy using plant air purifiers might even extend outside the realm of health insurance and be incorporated in life insurance coverage as well, whereby those taking out life insurance coverage or groups offering life insurance provide the insured with plant air purifiers so as to extend their lives and so enjoy longer periods during which premiums are being paid. In addition pools of only those having such plant air purifiers might actually result in lower annual premiums since such people in the pool provided with such plant air purifiers may actually have extended lives as compared to the normal population.

Among the claims which may be made on the basis of the foregoing are the following:

1. I claim a method by which health costs of a business entity, fraternal organization, municipal government or agency or the federal government or any of its agencies are reduced by the utilization of plant air purifiers to clean indoor air where employees, members or insured are so located either during working hours or after hours and that either the purchase or lease of said air purifiers are obtained or said air purifiers are supplied through an insurance company, a supplier of these devices to an insurance company, a supplier of said devices who sells to a companies or organizations, or a business entity which caters to the health insurance or health maintenance needs of an organization so mentioned above and that said supplier also uses a computer to keep track of those plant air purifiers dispensed.
2. I claim a method whereby the cost of health insurance or health protection is reduced for an employer by supplying plant air purifiers either to the employer at his place of business and/or plant air purifiers are supplied to employees for their residences thus reducing poor indoor air quality which has been shown to have an adverse effect upon health.
3. I claim a method whereby a group of plant air purifiers are supplied by a manufacturer to an employer for himself and his employees so as to reduce health costs. That the manufacturer or third party is responsible for installation and for maintenance of these units and that as a result of breathing in better indoor air supplied by these plant air purifiers members of the group health plan suffer less sickness and so their cost of health insurance and health expense is reduced.
4. I claim a method whereby at least one of the following, health insurance companies or self-insured group health plans of an organization, business or otherwise are able to reduce their health expenditures by supplying plant air purifiers to their employees, place of meeting or business or residences and that the insurance company or self-insured collect in either their premiums or in monies set aside to meet health claims monies to provide for either themselves or a third party sufficient funds to maintain, manufacture and/or install such systems so that employers, employees or members of such an organization enjoy better indoor air quality and so suffer less health expense in what is paid to doctors, hospitals and for prescriptions.
5. I claim a method whereby a health insurance company offers health insurance which offers the possibility of a rebate on an insured's health costs if members of an insured pay within their premium the cost of being supplied with plant air purifiers which reduce poor indoor air quality within the workplace or at its employees place of residence so that the air they breathe is purified and at least one of the following are removed or reduced from the indoor air supply they breathe, radon, ionizing radiation, mold, volatile organic compounds, pet dander, particulate matter, carbon dioxide, or biological. Cigarette smoke, carbon monoxide.
6. I claim a method whereby a life insurance company offers life insurance which offers reduced premiums on those policies as a result of the premium collected including within it monies which are supplied to a manufacturer or third party who supplies plant air purifiers to the insured so that the air they breathe in either at least one of the following, their place of work or residence have better quality air so helping to mitigate sickness and delaying death as a result by reducing at least one of the following in the indoor air they breathe: radon, mold, volatile organic compounds, pet dander, particulate matter, carbon dioxide, or biological. Cigarette smoke, carbon monoxide.
7. I claim a method whereby plant air purifiers are furnished for use by employers and employees so that the indoor air quality is improved where they reside either during at least one of the following their business or place of residence where they spend quite a few hours of the day and that this results in less monies being expended for health purposes for said people. I further claim that a computer is used to keep track at least one of the following: who the employer is and its employees. It will keep track of insurance premiums paid of at least one of the following, workman's compensation, disability insurance, health or life and of each claim being submitted for each member of a plan. It will keep track of the medical history of each member of the plan or at the very least the classification of each member. It will keep track of locations of the plant air purifiers and whether they need either continued maintenance on what schedule, checking to see when such maintenance was performed or whether in the case of portable units whether they need a replacement of unit or plant. Where drop off points for. Replacement can be picked up. Number of replacements. Cost or time spent in doing such maintenance. It will also keep track of sick days of the individual employees as well and the overall number of sick days of each employee per each employer health plan. Hand held computer or texting machines can feed in information to the overall plan or program as to time began to work on maintenance of built in units or of pick up and replacement, etc.
8. I claim a method whereby employers purchase or lease plant air purifiers for use by employers and employees so that the indoor air quality is improved where they reside either during at least one of the following their business or place of residence where they spend quite a few hours of the day and that this results in less monies being expended for health purposes for said people. I further claim that a computer is used to keep track at least one of the following: who the employer is and its employees. It will keep track of insurance premiums paid of at least one of the following, workman's compensation, disability insurance, health or life and of each claim being submitted for each member of a plan. It will keep track of the medical history of each member of the plan or at the very least the classification of each member. It will keep track of locations of the plant air purifiers and whether they need either continued maintenance on what schedule, checking to see when such maintenance was performed or whether in the case of portable units whether they need a replacement of unit or plant. Where drop off points for. Replacement can be picked up. Number of replacements. Cost or time spent in doing such maintenance. It will also keep track of sick days of the individual employees as well and the overall number of sick days of each employee per each employer health plan. Hand held computer or texting machines can feed in information to the overall plan or program as to time began to work on maintenance of built in units or of pick up and replacement, etc.
9. I claim a method by which employers utilize a plant air purifier with the intention of cutting down on health insurance costs and that as a result of such use the employer also enjoys at least one of the following benefits as well:

having cleaner indoor air supplied

Lower increase in health insurance rates

Lower disability premiums

Lower employee turnover and retraining costs

Lower workman compensation costs

Fewer sick days

An added chance of receiving insurance rebates

Added comfort on the part of employees, their families and employers alike

Reduced heating and cooling costs

Reduced carbon emissions

Having the firm known as having embraced green technology

Less risk of being involved in an IAQ lawsuit which is extremely expensive to defend and

Being involved in a wellness program where everyone participates since breathing is an involuntary act

Receiving depreciation benefits on the building wherein the company or employer is located.

10. A method by which plant air purifiers are supplied to the homes of those members of a group health plan who are in the top 1% of health expenditures within the plan so as to lower costs for the overall plan and its members.
11. A method by which plant air purifiers are supplied to the homes of those members of a group health plant who are in the top 5% of health expenditures within the plan so as to lower costs for the overall plan and its members.
12. A method by which plant air purifiers are supplied to the homes of those members of a group health plant who are in the top 10% of health expenditures within the plan so as to lower costs for the overall plan and its members.
13. A method by which the insurance pool used contains only those users of plant air purifiers.
14. A method whereby members of the group health insurance plan can lease additional portable units to place in other parts of their home or in the rooms of other members of their family living in the same home, whether those members are insured or not.
15. I claim a method by which the insured in life policies are equipped with plant air purifiers so that they might live longer, so increasing periods during which they pay premiums or result in lower annual premiums being paid since expected mortality may occur at an older age.
16. I claim a method by which those in an insured group are protected from the radiation from nuclear reactors.
17. I claim a method by which members of an insured group enjoy less stress due to plants placed in plant air purifiers being placed in their immediate surroundings.
18. I claim a method by which an employer who carries health insurance may receive an added benefit by having purer air which is treated by plant air purifiers actually passes on those benefits to members outside the group such as customers or those in the building which the employer owns or leases.
19. I claim a method whereby there would be an exclusionary clause within the agreement between the insured or insured group which leases plant air purifiers whereby once a lease has been made they may not cancel the lease and then purchase plant air purifiers without the express consent of those who had leased them such units for at least so many years.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A method by which an organization with plurality of employees and/or insureds and/or members takes steps intended to reduce its costs for providing healthcare, by establishing a wellness and prevention program which comprises at least one of the following:
paying for costs of installing plant air purifiers in a workplace of said employees and/or insureds and/or members;
paying for costs of installing plant air purifiers in places of residence of said employees and/or insureds; wherein:
said plant air purifiers include a mechanism for forcing air to pass through a filter bed thereof in which said plants are rooted.

2. The method of claim 1, further comprising:
paying for costs of maintaining said plant air purifiers in said workplace of said employees and/or insureds and/or members;
paying for costs of maintaining said plant air purifiers in said places of residence of said employees and/or insureds.

3. The method of claim 1, said organization comprising an organization selected from the organization group consisting of: a private business; a non-for profit organization; a health insurer; a life insurer; a disability insurer; a governmental body; a fraternal organization

4. The method of claim 1, further comprising:
paying for costs by providing funds directly to said employees and/or insureds and/or members with the requirement that said funds are to be used for said installation, either directly, or via a reduction or rebate in the cost of health insurance premiums.

5. The method of claim 2, further comprising:
paying for costs by providing funds directly to said employees and/or insureds and/or members with the requirement that said funds are to be used for said maintenance, either directly, or via a reduction or rebate in the cost of health insurance premiums.

6. The method of claim 1, wherein:
wherein said organization pays said costs for a subset of said employees and/or insureds and/or members who incur expenditures for health care costs in a predetermined top percentage of expenditures incurred among all of said employees and/or insureds and/or members.

7. The method of claim 6, wherein said predetermined top percentage is 1%.

8. The method of claim 6, wherein said predetermined top percentage is 5%.

9. The method of claim 6, wherein said predetermined top percentage is 10%.

10. The method of claim 1, further comprising a computerized device with associated computerized storage and data instructions and processing for at least one of the following and for connecting said at least one of the following to specific plant air purifiers of said employees and/or insureds and/or members:
tracking insurance premiums paid on behalf of said employees and/or insureds and/or members for at least one of the following: workman's compensation, disability, health and life, as well as claim being submitted for each member of a plan;
tracking medical history of said employees and/or insureds and/or members;
tracking sick day utilizations of said employees and/or insureds and/or members; further comprising;
tracking obtaining and installing said plant air purifiers;
tracking locations of said plant air purifiers and their maintenance history and requirements.
